(19) United States
(12) Patent Application Publication
(10) Pub. No.: US 2002/0036727 A1
(43) Pub. Date: Mar. 28, 2002

(54) Display device

(76) Inventor: Heinz-Gunther Wilhelm, Wiesbaden (DE)

Correspondence Address: Martin A. Farber, Suite 473, 866 United Nations Plaza, New York, NY, 10017, US

(21) Appl. No.: 09/801,195

(22) Filed: Mar. 6, 2001

(30) Foreign Application Priority Data
Mar. 8, 2000 (DE) 100 10 812.1

(51) Int. Cl. G02F 1/1333

(52) U.S. Cl. 349/56

(57) ABSTRACT

The invention relates to a display device (1), in particular in a vehicle, having a housing (3) on the front side of which facing a viewer a liquid crystal cell (2) is mounted, and having a printed circuit board which is arranged on the rear of the housing (3) and has the purpose of making electrical contact with the liquid crystal cell (2), a contacting element (8) which is clamped against the liquid crystal cell (2), is approximately plate-shaped and is guided at its larger sides (13, 14) in the housing (3) and has the purpose of making electrical connection with the printed circuit board and liquid crystal cell (2) being arranged between the printed circuit board and a contacting region (7) of the liquid crystal cell (2) which is arranged outside a display region (6) of the liquid crystal cell (2).

In order to make the display device easier to mount, the invention proposes that the housing (3) is provided with a first hook element (9), as mating holding element for the clamped contacting element (8), which engages over the liquid crystal cell (2) in the contacting region (7), and with a second hook element (10) which engages over the liquid crystal cell (2) in a region which lies opposite the contacting region (7) and is arranged outside the display region (6) of the liquid crystal cell (2), so as to form a single component.

The invention relates to a display device, in particular in a vehicle, having a housing on the front side of which facing a viewer a liquid crystal cell is mounted, and having a printed circuit board which is arranged on the rear of the housing and has the purpose of making electrical contact with the liquid crystal cell, a contacting element which is clamped against the liquid crystal cell, is approximately plate-shaped and is guided at its larger sides in the housing and has the purpose of making electrical connection with the printed circuit board and liquid crystal cell being arranged between the printed circuit board and a contacting region of the liquid crystal cell which is arranged outside a display region of the liquid crystal cell.

Such display devices are known, for example, as a component of combined display instruments in motor vehicles and are widespread. In such devices a metal frame which retains the liquid crystal cell and holds in on its sides locks to the housing on which the liquid crystal cell is mounted or to a printed circuit board. This entails a costly mounting procedure, in particular the process of joining the housing, frame and the contacting element to be guided in the housing has proven disadvantageous particularly in large-scale series production, such as is necessary for applications in the field of motor vehicles.

Furthermore, a display device with a liquid crystal cell mounted in a housing is known, the housing being locked to a printed circuit board. A compact contact strip is arranged between the printed circuit board and the liquid crystal cell. In this arrangement, which has a very low overall height, there is only a minimum distance between the liquid crystal cell and printed circuit board. As a result, on the one hand the contact strip does not need to be guided; on the other hand it is not possible to illuminate the liquid crystal cell with customary light sources arranged on the rear of the liquid crystal cell facing away from a viewer. Such a display device is thus completely unsuitable for use when there is only low ambient brightness and thus little incident light on the liquid crystal cell (for example in the ambient darkness in motor vehicles).

The invention is therefore based on the object of providing a display device of the type mentioned at the beginning, which display device is simple in terms of design and mounting and thus suitable for large-scale series production.

This object is achieved according to the invention in that the housing is provided with a first hook element, as mating holding element for the clamped contacting element, which engages over the liquid crystal cell in the contacting region, and with a second hook element which engages over the liquid crystal cell in a region which lies opposite the contacting region and is arranged outside the display region of the liquid crystal cell, so as to form a single component.

Such an embodiment advantageously reduces the number of necessary components for the display device. As a result, not only is it made easier to mount but also storage and handling costs are reduced. The device according to the invention ensures, by means of the engagement of the liquid crystal cell in its contacting region and in a section lying opposite this region, that the contacting element is permanently clamped. This results in a very high operational reliability of the display over its entire service life. This is of great significance in particular for information relating to safety, for example speed displays in motor vehicles. Furthermore, the subject-matter of the invention makes it possible, when required, to provide any desired spacing between the printed circuit board and liquid crystal cell within the scope of customary orders of magnitude. In the space which is provided in this way, it is possible, for example, to arrange illumination elements such as light sources, light guides or diffusing screens for the liquid crystal cell. This also permits liquid crystal cells to be freely located in display devices (for example combined display instruments for motor vehicles) having a plurality of displays, so that they form a uniform display surface with the other displays. The display device according to the invention ensures that the housing is not deformed despite the permanent clamping of the contacting element. It is thus ensured that the position of the liquid crystal cell will stay the same over the entire service life and the electrical contact with the cell will be maintained.

A satisfactory way of mounting the liquid crystal cell and permanently clamping the contacting element can be achieved in a display device according to the invention if the first hook element is elastically connected to a side wall of the housing. However, the position of the liquid crystal cell is also maintained precisely over a long time period, and the clamping of the contacting element is ensured if, according to an advantageous development of the invention, the first hook element is rigidly connected to a side wall of the housing. It is a particular advantage here if the side wall is reinforced by means of a web so that the housing and hook element form an arrangement which is fixed, even when temperature fluctuations occur, for example.

It is possible to conceive a first hook element which engages over the contacting region of the liquid crystal cell only in certain sections or at points. A particularly uniform pressure distribution and good formation of contact with the liquid crystal cell, contacting element and printed circuit board is, on the other hand, advantageously achieved if the first hook element engages over the contacting region approximately over its entire length.

According to another advantageous development of the invention, the second hook element is connected to the housing so that it is elastic approximately in the direction of the display plane of the liquid crystal cell. In this way, the liquid crystal cell can be mounted particularly easily in the housing by virtue of the fact that the cell can be inserted behind the first hook element and locked to the housing by means of the second hook element.

In this context, the second hook element may be connected to the housing so as to form a single component if it is advantageously arranged on an elastic side wall of the housing. The number of contact components of the housing is thus reduced and their manufacture is therefore considerably simplified. The elasticity of the side wall of the housing is advantageously achieved in such a way as to further simplify the design of the housing by virtue of the fact that the housing has two slots which are arranged in the same plane, approximately perpendicular with respect to the display plane of the liquid crystal cell, and form the elastic side wall.

The contacting element could be guided in the housing by, for example, a lateral arrangement of webs or arms. However, a particularly precise way of guiding, which avoids causing the contacting element to bulge and which is a particularly reliable way of making contact with the liquid crystal cell, contacting element and printed circuit board, is obtained if, according to one advantageous development of the invention, the housing has an outer side wall and an inner side wall which is approximately parallel to the latter and the contacting element is guided between said walls.

In order to ensure that the liquid crystal cell is supported in a uniform way in the housing and that the cell is held permanently, it is advantageous if a supporting element which is clamped between the liquid crystal cell and the printed circuit board is arranged on a side of the housing lying opposite the contacting element.

Liquid crystal cells are pressure-sensitive components, in particular pressure differences over the display surface of the cell can lead to disruptive falsifications of the display. For this reason, according to another advantageous development of the invention it is favorable if the supporting element and the contacting element have approximately identical elastic properties so that the liquid crystal cell is subjected to a uniform pressure.

The mechanical design of the display device is particularly stable and durable if, according to another advantageous development of the invention, the supporting element is guided in the housing between an external side wall and a housing internal side wall lying opposite the latter.

It is particularly useful if the supporting element is electrically conductive. In this way, contact can be made between the liquid crystal cell and the printed circuit board not only by means of the contacting element but also additionally by means of the supporting element.

In particular if the display device has other displays apart from the liquid crystal cell, for example displays forming a combined display instrument in a motor vehicle, very precise positioning of the liquid crystal cell in the housing (and also with respect to a dial plate which may be present) is highly significant. For such precise positioning of the liquid crystal cell it is of particular advantage if, according to another development of the invention, the housing has webs which lie opposite each other and which guide the liquid crystal cell on sides over which a hook element does not engage.

The contacting element and/or the supporting element can be manufactured particularly cost-effectively, even in large numbers, and can be handled easily if it is a conductive rubber.

The housing could be composed of a plurality of elements and/or embodied, for example, as a canted and bent metal component. However, according to another development of the invention, it is particularly advantageous if the housing is a plastic injection molded component. In this way, the housing can be manufactured in a single operation so as to form a single component with the hook elements and supporting elements, as well as the walls. In addition, it is thus advantageously possible to embody the housing in the form of a central housing for a combined display instrument which has receptacles and/or light guides and/or mounts for further display elements.

According to another advantageous development of the invention, the housing is in two parts, the first housing part having external housing walls and the second housing part which can be inserted into the first housing part having internal housing walls as a result of which housing parts with a simple geometry can be particularly easily obtained. The geometry of the housing is further simplified here, as is the assembly of the display device, if, according to another advantageous development of the invention, the distance between the inner housing wall and the external housing wall in the vicinity of the contacting element and/or of the supporting element corresponds approximately in each case to the thickness of the contacting element and/or of the supporting element.

Here, it is highly advantageous for stock keeping and handling of the housing components before the display device is mounted if the first housing part and the second housing part are connected to one another so as to form a single component. Housing parts which respectively belong together are in this way not only automatically assigned to one another but also captively connected to one another. The connection does not impede the mounting of the housing and takes up only a very small volume of material if the first housing part and the second housing part are advantageously connected to each other by means of a film. Housing parts which are connected in such a way can also be manufactured particularly easily using a plastic injection molding method, the film being a plastic film which is connected to the housing parts so as to form a single component.

The invention is explained in more detail below by means of exemplary embodiments illustrated in the appended drawing, in which:

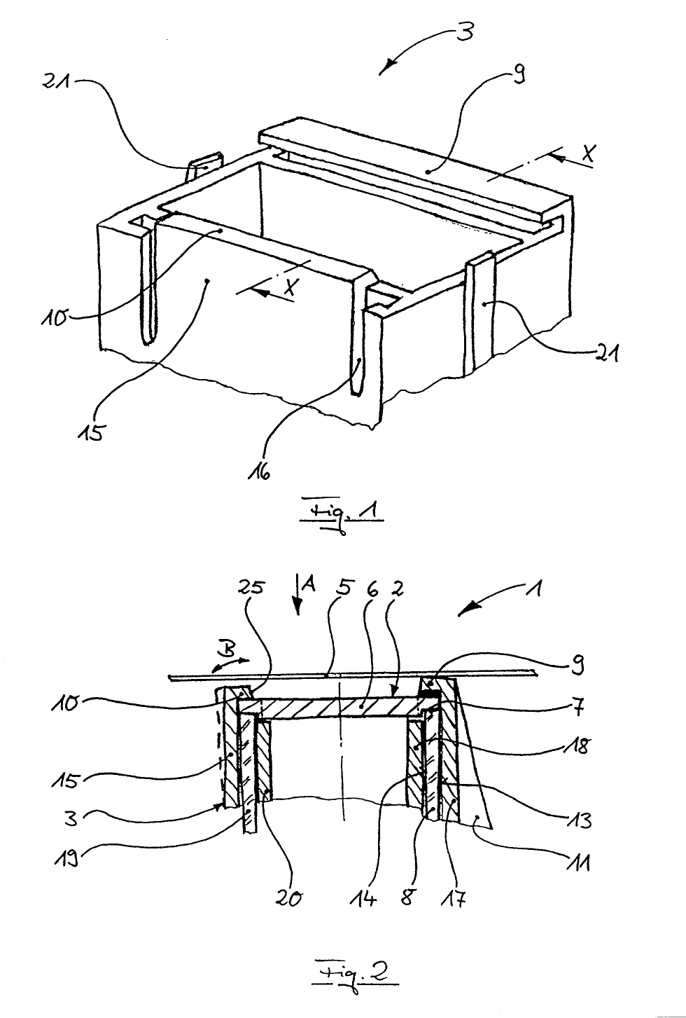

FIG. 1 shows a housing of a display device according to the invention in a perspective view,

FIG. 2 shows a vertical section through the display device with the housing according to FIG. 1,

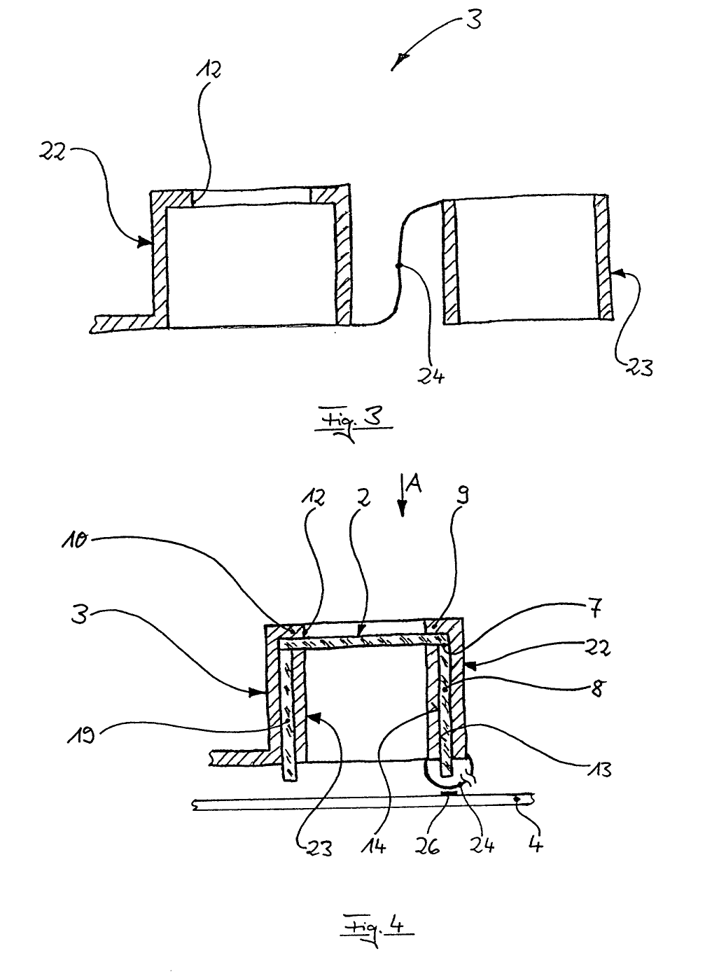

FIG. 3 shows a further housing in a sectional side view, and

FIG. 4 shows a housing according to FIG. 3 with a liquid crystal cell inserted into it.

FIG. 1 shows a housing 3, embodied as a plastic injection-molded component, of a display device (not illustrated here in further detail) of a motor vehicle. The housing 3 has a box-shaped design with a first hook element 9 which is arranged on a longitudinal side of the housing 3, and a second hook element 10 lying opposite the first hook element 9. Webs 21 are arranged on the narrow sides of the housing 3, one of which webs 21 is constructed in a sprung fashion so as to compensate fabrication tolerances. The second hook element 10 is arranged on an elastic side wall 15, also sprung, of the housing 3. The spring property of the side wall 15 is achieved here by means of vertical slits 16 which separate the side wall 15 laterally from the housing 3.

In FIG. 2, a display device 1 with the housing 3 is shown corresponding to a section along the line X-X in FIG. 1. Mounted on the housing 3 is a liquid crystal cell 2 with a display region 6 which can be read by a viewer in the viewing direction A through a transparent region of a dial plate 5. On a contacting region 7 of the liquid crystal cell 2 bears a contacting element 8 which is formed by a conductive rubber, in the same way as it bears on a corresponding contacting region of a printed circuit board (not illustrated). The contacting element 8 is of planar design and has a first larger side 13 and a second larger side 14 on which it is guided in the housing 3. For this purpose, the contacting element 8 is inserted between an inner side wall 18 and a side wall 17 of the housing 3 which is parallel to the latter and connected rigidly to the first hook element 9. The side wall 17 is reinforced with a web 11, and the contacting element 8 is clamped between the printed circuit board and the contacting region 7 of the liquid crystal cell 2.

On the side of the housing 3 lying opposite the contacting element 8 a supporting element 19 is clamped between the liquid crystal cell 2 and the printed circuit board. The supporting element 19 is guided in the housing 3 between the elastic external side wall 15 and an internal side wall 20 lying opposite the latter. The side wall 15 is mobile in one direction B with the result that during the mounting operation the liquid crystal cell 2 is pushed in under the hook element 9 and can bear against the housing 3 while the side wall 15 is simultaneously pulled back, after which the liquid crystal cell 2 is locked by means of the side wall 15 which clicks back and with the aid of the second hook element 10. A slope 25 on the hook element 10 makes it easier to join the liquid crystal cell 2 and housing 3 here.

A further embodiment of a housing 3 is illustrated in FIG. 3. This housing 3 has a first, trough-shaped housing part 22 with a recess 12 which is located on the floor of the housing part 22, and a frame-shaped second housing part 23. The first housing part 22 and the second housing part 23 are connected by means of a sprayed-on film 24. The second housing part 23 can be inserted into the first housing part 22, internal walls of the housing 3 being formed by the second housing part 23, and external walls of the housing 3 being formed by the first housing part 22.

As is clear from FIG. 4, a liquid crystal cell 2 can be read through the recess 12 from the viewing direction A. The housing 3 is provided with a first hook element 9 which engages over the liquid crystal cell 2 in a contacting region 7, and with a second hook element 10 which engages over the liquid crystal cell 2 in a region lying opposite the contacting region 7, so as to form a single component. The hook elements 9, 10 are embodied here on the first housing part 22 and clamp a contacting element 8 or a supporting element 19 between the liquid crystal cell 2 and a printed circuit board 4 which is illustrated here for the sake of clarity spaced apart from the contacting element 8 and the supporting element 19 in a position which is not the final mounted one (in the final position the housing parts 22, 23 and the contacting element 8 bear against the printed circuit board 4).

It can be seen that the larger sides 13, 14 of the contacting element 8 are guided between the housing parts 22, 23 in the housing 3. After the joining process, the contacting element 8 forms contact between the contacting region 7 of the liquid crystal cell 2 and a contacting region 26 of the printed circuit board 4. The film 24 which connects the housing parts 22, 23 and which is arranged as a narrow strip adjacent to the side of the contacting element 8 is squeezed in between the housing 3 and printed circuit board 4 in a way which does not disrupt the assembly.

1. A display device (1), in particular in a vehicle, having a housing (3) on the front side of which facing a viewer a liquid crystal cell (2) is mounted, and having a printed circuit board (4) which is arranged on the rear of the housing (3) and has the purpose of making electrical contact with the liquid crystal cell (2), a contacting element (8) which is clamped against the liquid crystal cell (2), is approximately plate-shaped and is guided at its larger sides (13, 14) in the housing (3) and has the purpose of making electrical connection with the printed circuit board (4) and liquid crystal cell (2) being arranged between the printed circuit board (4) and a contacting region (7) of the liquid crystal cell (2) which is arranged outside a display region (6) of the liquid crystal cell (2), wherein the housing (3) is provided with a first hook element (9), as mating holding element for the clamped contacting element (8), which engages over the liquid crystal cell (2) in the contacting region (7), and with a second hook element (10) which engages over the liquid crystal cell (2) in a region which lies opposite the contacting region (7) and is arranged outside the display region (6) of the liquid crystal cell (2), so as to form a single component.

2. The display device as claimed in claim 1, wherein the first hook element (9) is rigidly connected to a side wall (17) of the housing (3).

3. The display device as claimed in claim 2, wherein the side wall (17) is reinforced by means of a web (11).

4. The display device as claimed in one of the preceding claims, wherein the first hook element (9) engages over the contacting region (7) approximately over its entire length.

5. The display device as claimed in one of the preceding claims, wherein the second hook element (10) is connected to the housing (3) so that it is elastic approximately in the direction of the display plane of the liquid crystal cell (2).

6. The display device as claimed in claim 5, wherein the second hook element (10) is arranged on an elastic side wall (15) of the housing (3).

7. The display device as claimed in claim 6, wherein the housing (3) has two slots (16) which are arranged in the same plane, approximately perpendicular with respect to the display plane of the liquid crystal side (2), and form the elastic side wall (15).

8. The display device as claimed in one of the preceding claims, wherein the housing (3) has an external side wall (17) and an internal side wall (18) which is approximately parallel to the latter and between which walls (17, 18) the contacting element (8) is guided.

9. The display device as claimed in one of the preceding claims, wherein a supporting element (19) which is clamped between the liquid crystal cell (2) and the printed circuit board (4) is arranged on a side of the housing (3) lying opposite the contacting element (8).

10. The display device as claimed in claim 9, wherein the supporting element (19) and the contacting element (8) have approximately the same elastic properties.

11. The display device as claimed in claim 9 or 10, wherein the supporting element (19) is guided in the housing (3) between an external side wall (15) and an internal side wall (20), lying opposite the latter, of the housing (3).

12. The display device as claimed in one of claims 9 to 11, wherein the supporting element (19) is electrically conductive.

13. The display device as claimed in one of the preceding claims, wherein the housing (3) has webs (21) which lie opposite each other and guide the liquid crystal cell (2) on sides over which a hook element (9, 10) does not engage.

14. The display device as claimed in one of the preceding claims, wherein the contacting element (8) and/or the supporting element (19) is conductive rubber.

15. The display device as claimed in one of the preceding claims, wherein the housing (3) is a plastic injection molded component.

16. The display device as claimed in one of the preceding claims, wherein the housing (3) is in two parts, the first housing part (22) having external housing walls and the second housing part (23) which can be inserted into the first housing part (22) having internal housing walls.

17. The display device as claimed in claim 16, wherein, in the vicinity of the contact element (8) and/or of the supporting element (19), the distance between the inner housing wall and the outer housing wall corresponds approximately to the thickness of the contacting element (8) and/or of the supporting element (19).

18. The display device as claimed in claim 16 or 17, wherein the first housing part (22) and the second housing part (23) are connected to one another so as to form a single component.

19. The display device as claimed in claim 18, characterized in that the first housing part (22) and the second housing part (23) are connected to a film (24).
